(19) United States
(12) Patent Application Publication
(10) Pub. No.: US 2022/0213966 A1
(43) Pub. Date: Jul. 7, 2022

(54) SHUTTLE VALVE SPOOL ASSEMBLY

(71) Applicant: The Boeing Company, Chicago, IL (US)

(72) Inventor: Chandra Sudhakar Gudimetla, Bengaluru (IN)

(73) Assignee: The Boeing Company, Chicago, IL (US)

(21) Appl. No.: 17/524,567

(22) Filed: Nov. 11, 2021

Related U.S. Application Data
(60) Provisional application No. 63/134,124, filed on Jan. 5, 2021.

(51) Int. Cl. F16K 11/044; F16K 27/02; F15B 13/02

(52) U.S. Cl. CPC F16K 11/044; F15B 13/028; F16K 27/0263

(57) ABSTRACT

A device including a sleeve having a first end, a second end opposite the first end, and a hole disposed through an outer diameter of the sleeve between the first end and the second end. The device includes a spool having a third end and a fourth end opposite the third end, the spool disposed at least partially inside the sleeve and configured to slide along a longitudinal axis of the sleeve. The device includes a spring having a fifth end and a sixth end opposite the fifth end, the spring disposed in a slot disposed in the spool, the spring and the slot oriented at least partially in a radial direction relative to the longitudinal axis. The device also includes a retaining bit disposed at the fifth end of the spring. The spring, in a partially compressed state, urges the retaining bit against an inner wall of the sleeve.

### RELATED APPLICATIONS

This application claims priority to U.S. Provisional Patent Application 63/134,124, filed Jan. 5, 2021, the entirety of which is hereby incorporated by reference.

### BACKGROUND

Many aircraft use hydraulic systems for a variety of tasks, including, for example, in braking systems. Hydraulic systems include various components to control the flow and pressure of fluid within the fluid lines.

### SUMMARY

The one or more embodiments provide for a device. The device includes a sleeve having a first end, a second end opposite the first end, and a hole disposed through an outer diameter of the sleeve between the first end and the second end. The device also includes a spool having a third end and a fourth end opposite the third end, the spool disposed at least partially inside the sleeve and configured to slide along a longitudinal axis of the sleeve. The device also includes a spring having a fifth end and a sixth end opposite the fifth end, the spring disposed in a slot disposed in the spool, the spring and the slot oriented at least partially in a radial direction relative to the longitudinal axis. The device also includes a retaining bit disposed at the fifth end of the spring. The spring, in a partially compressed state, urges the retaining bit against an inner wall of the sleeve.

The one or more embodiments also provide for a shuttle valve. The shuttle valve includes a housing having a first inlet, a second inlet, an outlet, and a manifold chamber in fluid communication with the first inlet, the second inlet, and the outlet. The shuttle valve also includes a sleeve disposed in the manifold chamber, the sleeve having a first end, a second end opposite the first end, and a first hole and a second hole disposed through an outer diameter of the sleeve between the first end and the second end. The shuttle valve also includes a spool having a third end and a fourth end opposite the third end, the spool disposed at least partially inside the sleeve and configured to slide along a longitudinal axis of the sleeve. The shuttle valve also includes a spring having a fifth end and a sixth end opposite the fifth end, the spring disposed in a slot disposed in the spool, the spring and the slot oriented at least partially in a radial direction relative to the longitudinal axis. The shuttle valve also includes a retaining bit disposed at the fifth end of the spring. The spring, in a partially compressed state, urges the retaining bit against an inner wall of the sleeve.

The one or more embodiments also provide for an aircraft. The aircraft includes a fuselage. The aircraft also includes a hydraulic system connected to the fuselage, the hydraulic system having a first fluid line, a second fluid line, a third fluid line, and a shuttle valve. The shuttle valve includes a housing having a first inlet connected to the first fluid line, a second inlet connected to the second fluid line, an outlet connected to the third fluid line, and a manifold chamber in fluid communication with the first inlet, the second inlet, and the outlet. The shuttle valve also includes a sleeve disposed in the manifold chamber, the sleeve having a first end, a second end opposite the first end, and a first hole and a second hole disposed through an outer diameter of the sleeve between the first end and the second end. The shuttle valve also includes a spool having a third end and a fourth end opposite the third end, the spool disposed at least partially inside the sleeve and configured to slide along a longitudinal axis of the sleeve. The shuttle valve also includes a spring having a fifth end and a sixth end opposite the fifth end, the spring disposed in a slot disposed in the spool, the spring and the slot oriented at least partially in a radial direction relative to the longitudinal axis. The shuttle valve also includes a retaining bit disposed at the fifth end of the spring. The spring, in a partially compressed state, urges the retaining bit against an inner wall of the sleeve.

Other aspects of the invention will be apparent from the following description and the appended claims.

### BRIEF DESCRIPTION OF DRAWINGS

FIG. 1 shows an aircraft, in accordance with one or more embodiments.

FIG. 2 shows a shuttle valve, in accordance with one or more embodiments.

FIG. 3 shows another shuttle valve, in accordance with one or more embodiments.

FIG. 4 shows a cross section of the shuttle valve in FIG. 2, in accordance with one or more embodiments.

FIG. 5 shows a variation of a spool with spring for a shuttle valve, in accordance with one or more embodiments.

FIG. 6 shows a variation of a spool with multiple spring for a shuttle valve, in accordance with one or more embodiments.

FIG. 7 shows a variation of a spool with a spring in a through-hole for a shuttle valve, in accordance with one or more embodiments.

FIG. 8 illustrates an aircraft manufacturing and service method, in accordance with one or more embodiments.

FIG. 9 illustrates an aircraft, in accordance with one or more embodiments.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

The term “about,” when used with respect to a physical property that may be measured, refers to an engineering tolerance anticipated or determined by an engineer or manufacturing technician of ordinary skill in the art. The exact quantified degree of an engineering tolerance depends on the product being produced and the technical property being measured. For a non-limiting example, two angles may be “about congruent” if the values of the two angles are within ten percent of each other. However, if an engineer determines that the engineering tolerance for a particular product should be tighter, then “about congruent” could be two angles having values that are within one percent of each other. Likewise, engineering tolerances could be loosened in other embodiments, such that “about congruent” angles have values within twenty percent of each other. In any case, the ordinary artisan is capable of assessing what is an acceptable engineering tolerance for a particular product, and thus is capable of assessing how to determine the variance of measurement contemplated by the term “about.”

As used herein, the term “connected to” contemplates at least two meanings. In a first meaning, unless otherwise stated, “connected to” means that component A was, at least at some point, separate from component B, but then was later joined to component B in either a fixed or removably attached arrangement. In a second meaning, unless otherwise stated, “connected to” means that component A could have been integrally formed with component B. Thus, for example, assume a bottom of a pan is “connected to” a wall of the pan. The term “connected to” may be interpreted as the bottom and the wall being separate components that are snapped together, welded, or are otherwise fixedly or removably attached to each other. Additionally, the term “connected to” also may be interpreted as the bottom and the wall being contiguously together as a monocoque body formed by, for example, a molding process. In other words, the bottom and the wall, in being “connected to” each other, could be separate components that are brought together and joined, or may be a single piece of material that is bent at an angle so that the bottom panel and the wall panel are identifiable parts of the single piece of material.

In general, embodiments of the invention relate to an improved shuttle valve. In known shuttle valves, the shuttle mechanism has a sleeve and spool with a ball retaining bit, including one or more C-spring plates and one or more corresponding spherical balls. However, the C-spring plates may lead to inconsistent performance due to spring back issues and non-conformance to engineering tolerances. Furthermore, a spherical ball is retained by a C-spring. If a C-spring fails, the ball may escape, resulting in FOD (foreign object debris) in the shuttle valve and potentially elsewhere in the hydraulic system. Additionally, maintenance or disassembly of the shuttle valve may degrade the spring constant of the C-spring, leading to out-of-tolerance performance of the shuttle valve.

The one or more embodiments address these and other issues using a new shuttle valve configuration with respect to the sleeve, spool, compression spring, and retaining bit (which may be a spherical ball). Grooves for the retaining bit(s) are inverted from the spool to the sleeve, relative to the known shuttle valve, to locate the spherical ball in a desirable location. A compression spring is mounted into a hole provided in the spool, providing for a compact design which supports the spring, and providing for a defined preload on the retaining bit. This arrangement ensures that the retaining bit remains in contact with the sleeve. When the spool moves from one position to other position within the shuttle valve, the retaining bit moves along the groove's inclined surfaces, which in turn compresses the spring to achieve the pre-selected pressure engineered for the particular shuttle valve. Additional details and variants of the improved shuttle valve are now described with respect to the figures.

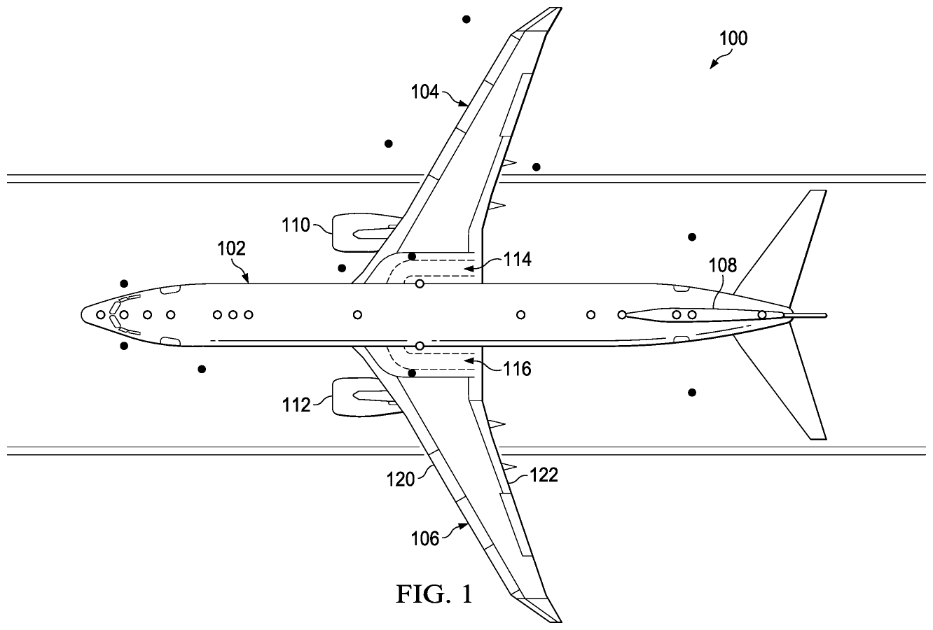

FIG. 1 shows an aircraft, in accordance with one or more embodiments of the invention. The aircraft (100) may include a fuselage (102) and one or more wings, such as first wing (104) and second wing (106). The aircraft (100) may also include a tail (108) and a propulsion system, such as first engine (110) and second engine (112). The aircraft (100) may also include one or more landing gear systems, such as first landing gear system (114) and second landing gear system (116).

The aircraft (100) may also include one or more hydraulic systems. For example, the one or more landing gear systems may include a braking system which includes hydraulics useful for braking the aircraft during landing. The aircraft (100) may also include a flap manipulation assembly (120) which allows the flaps (122) to be moved during various phases of aircraft operation, which also may be powered by hydraulics.

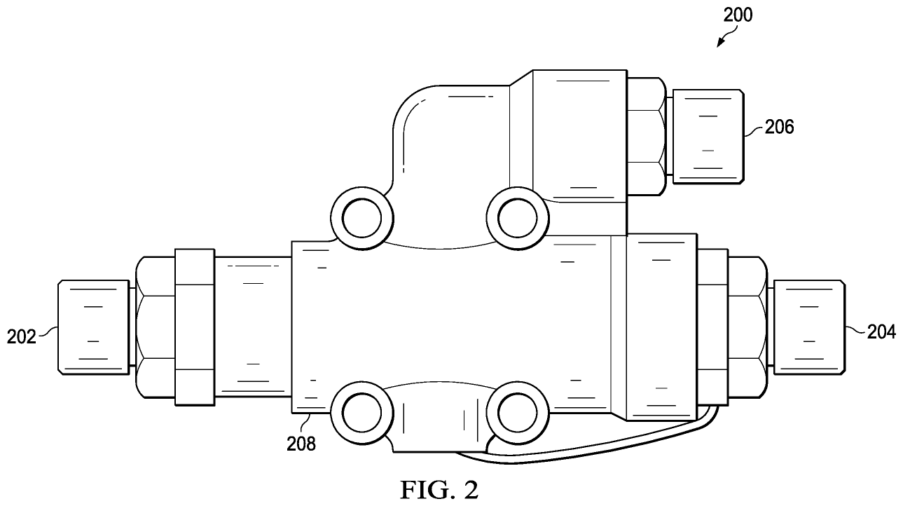

FIG. 2 shows a shuttle valve, in accordance with one or more embodiments. The shuttle valve (200) may be part of the hydraulic system(s) described with respect to FIG. 1.

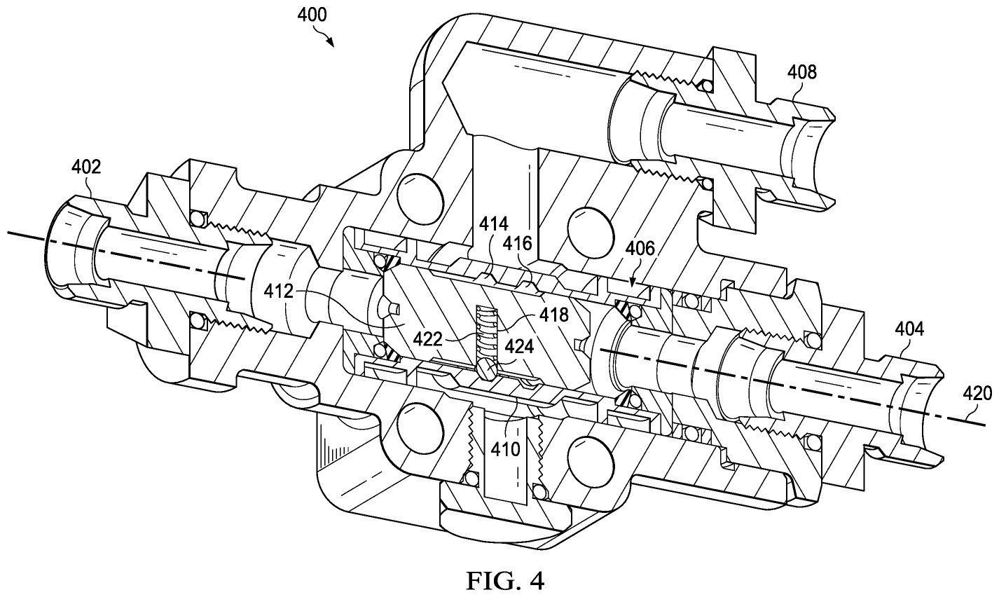

A shuttle valve is a hydraulic component that allows fluid and fluid pressure to be communicated from one of two inlets to a single outlet. A spool or “shuttle” inside the shuttle valve (200) blocks one or the other of the inlets. When a first pressure from one of the inlets exceeds a second pressure from the other of the inlets, then the spool slides to the other side of an inner chamber of the shuttle valve (200), opening the formerly blocked inlet and closing the formerly open inlet. This arrangement is shown in FIG. 4.

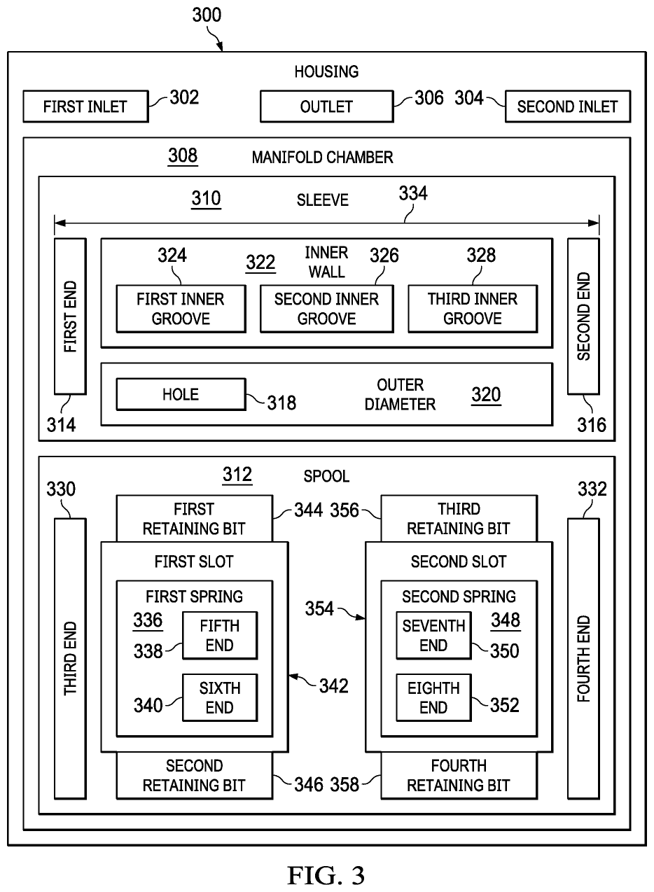

Thus, the shuttle valve (200) includes first inlet (202), second inlet (204), and outlet (206). Fluid may flow into either the first inlet (202) or the second inlet (204), but not both concurrently due to the operation of the spool inside the manifold chamber (208). Details of an improved version of the shuttle valve (200) are shown in FIG. 3 and FIG. 4.

FIG. 3 shows another shuttle valve, in accordance with one or more embodiments. The shuttle valve shown in FIG. 3 includes a housing (300) having a first inlet (302), a second inlet (304), and an outlet (306), much like the shuttle valve (200) shown in FIG. 2. Inside the housing (300) is a manifold chamber (308) having a sleeve (310) and a spool (312) disposed inside the sleeve (310). This arrangement is also shown in FIG. 4.

Attention is first turned to the sleeve (310). The sleeve (310) includes a first end (314), a second end (316) opposite the first end (314). A hole (318) is disposed through an outer diameter (320) of the sleeve (310) between the first end (314) and the second end (316). The hole (318) allows fluid to flow from one or the other of the first inlet (302) or the second inlet (304), through the sleeve (310), and to the outlet (306). More holes may be present. The sleeve (310) may also include an inner wall (322) facing the manifold chamber (308). The inner wall (322) may have a number of inwardly facing grooves, such as a first inner groove (324), a second inner groove (326), and a third inner groove (328). More or fewer inner grooves may be present.

Attention is now turned to the spool (312). The spool (312) includes a third end (330) and a fourth end (332) opposite the third end (330). The terms “third end” and “fourth end” do not necessarily connotate different orientations of the spool (312) relative to the sleeve (310), but rather are terms used to avoid confusion with the use of the term “first” and “second” with respect to the sleeve (310). The spool (312) is disposed at least partially inside the sleeve (310) and is configured to slide along a longitudinal axis (334) of the sleeve (310).

A first spring (336) having a fifth end (338) and a sixth end (340) opposite the fifth end (338), is disposed in a first slot (342) disposed in the spool (312). The first spring (336) and the first slot (342) are oriented at least partially in a radial direction relative to the longitudinal axis (334).

A first retaining bit (344) is disposed at the fifth end (338) of the first spring (336). The first retaining bit (344) may be a spherical ball in some embodiments, but in other embodiments may be a cube, a cylinder, or some other three dimensional solid object. The first spring (336), in a partially compressed state, urges the first retaining bit (344) against the inner wall (322) of the sleeve (310). Optionally, a second retaining bit (346) may be similarly situated at the opposite, sixth end (340), of the first spring (336).

The first inner groove (324), the second inner groove (326), and/or the third inner groove (328) may be sized and dimensioned to receive the first retaining bit (344). The first inner groove (324), the second inner groove (326), and/or the third inner groove (328) may be placed along the longitudinal axis (334) in a manner that when the first retaining bit (344) is disposed in a corresponding inner groove, an end of the spool (312) blocks one or the other of the first inlet (302) and the second inlet (304).

Not all grooves may be present. For example, in one arrangement, when the first retaining bit (344) is disposed in the first inner groove (324), the third end (330) of the spool (312) blocks the first inlet (302) while leaving the second inlet (304) open. Similarly, when the first retaining bit (344) is disposed in the second inner groove (326), the fourth end (332) of the spool (312) blocks the second inlet (304) while leaving the first inlet (302) open. This operation is also shown in FIG. 4.

The third inner groove (328) may be present when more than one spring is disposed in the spool (312). Thus, the spool (312) may include a second spring (348), having a seventh end (350) and an eighth end (352), disposed in a second slot (354) in the spool (312). The second spring (348) urges a third retaining bit (356) against the third inner groove (328) or the second inner groove (326), depending on the position of the spool (312) in the manifold chamber (308). If the second slot (354) is a through slot, then the second spring (348) may also urge a fourth retaining bit (358) against the second inner groove (326) or the third inner groove (328).

The first slot (342) and the second slot (354) may have different orientations in the spool (312). In one embodiment, the first slot (342) and/or the second slot (354) (and their corresponding spring) are disposed about perpendicular to the longitudinal axis (334). However, the slots may be angled relative to the longitudinal axis (334) in different embodiments.

Other embodiments are possible. For example, either or both of the first spring (336) and the second spring (348) may be a helical spring. Either or both of the first slot (342) and the second slot (354) may be a blind hole slot or a through slot. A single retaining bit is used in the case of a blind hole slot, and two opposing retaining bits on either side of the spring are used in the case of a through-hole slot.

In still other embodiments, the sleeve (310) nay be a cylindrical sleeve and the spool (312) may be a cylindrical spool. In this case, the first inner groove (324) may be a first circular inner groove in the inner wall (322), the first circular inner groove inwardly facing and sized and dimensioned to receive the first retaining bit (344) and/or the second retaining bit (346). Similarly, the second inner groove (326) or the third inner groove (328) may be characterized as a second circular inner groove in the inner wall (322) a distance along the longitudinal axis (420) from the first inner groove. The second circular inner groove is inwardly facing and sized and dimensioned to receive the first retaining bit (344) and/or the second retaining bit (346).

While FIG. 3 shows a configuration of components, other configurations may be used without departing from the scope of the invention. For example, various components may be combined to create a single component. As another example, the functionality performed by a single component may be performed by two or more components.

FIG. 4 through FIG. 7 show examples of specific shuttle valves having spring-spool assemblies as described above. The following examples are for explanatory purposes only and not intended to limit the scope of the claimed inventions.

FIG. 4 shows a cross section of the shuttle valve in FIG. 2, in accordance with one or more embodiments. The shuttle valve (400) shown in FIG. 4 is also a variation of the shuttle valve shown in FIG. 3.

The shuttle valve (400) includes a first inlet (402) and a second inlet (404) that are in fluid communication with a manifold chamber (406). An outlet (408) is also in fluid communication with the manifold chamber (406).

A sleeve (410) is disposed inside the manifold chamber (406). A spool (412) (or “shuttle”) is disposed inside the sleeve (410). The sleeve (410) includes a first inner groove (414) and a second inner groove (416), both of which are circular and disposed in an inner wall of the sleeve (410).

The spool (412) includes a slot (418), which in this example is disposed perpendicular to a longitudinal axis (420) of the shuttle valve (400). In this example, the slot (418) is a blind hole slot. A spring (422) is disposed inside the slot (418). One end of the spring (422) is disposed against the bottom of the slot (418), while the other end of the spring (422) presses against a retaining bit (424). In this example, the retaining bit (424) is a spherical ball that is sized and dimensioned to fit within both the first inner groove (414) and the second inner groove (416) of the sleeve (410).

In use, the spool (412) begins in a first position. In the first position, one end of the spool (412) blocks the first inlet (402). The spring (422) urges the retaining bit (424) into the first inner groove (414), thereby creating a retaining force which prevents the spool (412) from sliding along the longitudinal axis (420) within the sleeve (410) inside the manifold chamber (406).

However, when a first fluid pressure from the first inlet (402) exceeds a second fluid pressure from the second inlet (404) by a threshold degree, then the retaining force is overcome by the differential in fluid pressure. As a result, the retaining bit (424) compresses the spring (422) inside the slot (418), and the retaining bit (424) then rolls along the longitudinal axis (420) in the direction of the second inlet (404). In this manner, the spool (412) moves along the longitudinal axis (420) until the retaining bit (424) reaches the second inner groove (416) of the sleeve (410). In other words, when the fluid pressure between the inlets changes more than a certain amount, the retaining bit (424) compresses the spring (422), the spool (412) is no longer retained, and thus the spool (412) moves from one end of the manifold chamber (406) to the other.

In this manner, the spool (412) arrives at a second position. In the second position, the other end of the spool (412) blocks the second inlet (404), but allows fluid to flow from the first inlet (402) to the manifold chamber (406). In the second position, the retaining bit (424) is urged by the spring (422) into the second inner groove (416), which is sized and dimensioned to receive the retaining bit (424). In this manner, another retaining force is generated which will keep the spool (412) in the second position until the pressure differential between the first inlet (402) and the second inlet (404) changes again to force the spool (412) to move back to the first position.

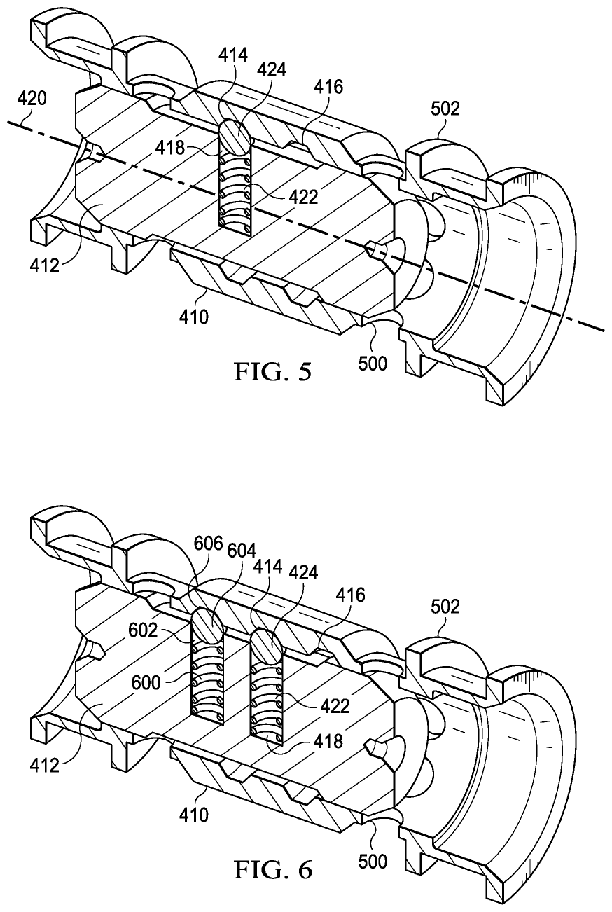

FIG. 5 shows a variation of a spool with spring for a shuttle valve, in accordance with one or more embodiments. In particular, FIG. 5 shows a more detailed view of the sleeve (410) and the spool (412) shown in FIG. 4. Thus, reference numerals in FIG. 5 which share the same reference numerals used in FIG. 4 refer to common objects having common definitions. The orientation of the sleeve (410) and the first inner groove (414) have also been flipped about the longitudinal axis (420) for a different perspective.

As can be seen in FIG. 4, the spring (422) in the slot (418) urges the retaining bit (424) into the first inner groove (414) of the sleeve (410). When the pressure differential between the two ends of the sleeve (410) becomes large enough, the first inner groove (414) is compressed into the spring (422), and the sleeve (410) slides along the longitudinal axis (420) until the retaining bit (424) moves into the second inner groove (416) of the sleeve (410).

FIG. 5 also shows additional details. For example, the sleeve (410) may include one or more holes, such as hole (500). The hole (500) or holes in the sleeve (410) allows fluid to flow from an inlet, through the hole (500), and on towards the outlet. As can be seen, a first set of holes may be on one side of the sleeve (410), and a second set of holes (including the hole (500)) may be on the other side of the sleeve (410). The first set of holes is blocked when the spool (412) is in the first position, but the second set of holes is blocked when the spool (412) is in the second position.

In addition, the sleeve (410) may also be provided with one or more flanges or detents, including flange (502) shown in FIG. 4. The flange (502) supports the sleeve (410) against the inner walls of the manifold chamber (see the manifold chamber (406) in FIG. 4). In this example, the flange (502) take the form of a circular (or annular) flange (or detent).

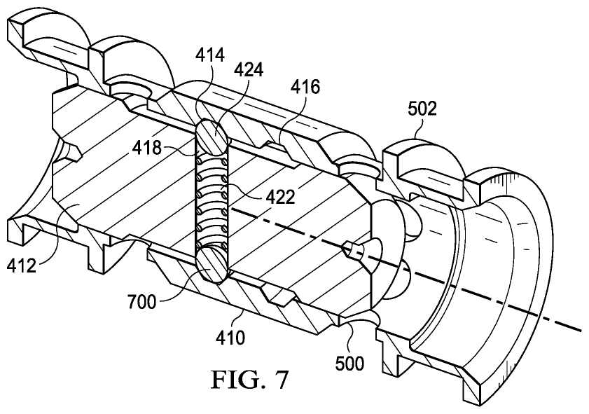

FIG. 6 and FIG. 7 show additional variations of the embodiments shown in FIG. 3, FIG. 4, and FIG. 5. FIG. 6 shows a variation of a spool with multiple spring for a shuttle valve, in accordance with one or more embodiments. FIG. 7 shows a variation of a spool with a spring in a through-hole for a shuttle valve, in accordance with one or more embodiments. Again, because the arrangement of the sleeve (410) relative to the spool (412) is similar in all four of FIG. 4 through FIG. 7, common reference numerals are used with respect to the reference numerals shown in FIG. 4.

In the variation shown in FIG. 6, two springs are disposed in two slots within the spool (412). Thus, in addition to the spring (422) in the slot (418), a second spring (600) is in a second slot (602) in the spool (412). In this example, both of the slots, slot (418) and second slot (602), are blind hole slots.

In addition, a third inner groove (606) is disposed in the inner wall of the sleeve (410). In the first position of the spool (412) (as shown in FIG. 6), the second spring (600) urges a second retaining bit (604) into the third inner groove (606). Concurrently, the spring (422) also urges the retaining bit (424) into the first inner groove (414) of the sleeve (410).

In use, the fluid pressure differential between the two inlets must overcome the combination of the retaining forces of the retaining bit (424) in the first inner groove (414) and the second retaining bit (604) in the second inner groove (416) in order for the spool (412) to slide longitudinally within the sleeve (410). When the fluid pressure differential overcomes the combined retaining force, the two retaining bits compress their respective springs as the spool (412) slides into a second position within the sleeve (410). When this occurs, the two retaining bits are disposed in different inner grooves, relative to the first position (the second spool position is not shown in FIG. 6). In particular, the retaining bit (424) will move from the first inner groove (414) to the second inner groove (416), while concurrently the second retaining bit (604) will move from the third inner groove (606) to the first inner groove (414). In this manner, the embodiment of FIG. 6 can create an increased retaining force for different expected pressures in different applications.

FIG. 7 shows yet another variation of the spring, retaining bit, and sleeve arrangement. In the example of FIG. 7, the slot (418) is a through-slot that extends through the spool (412). Note that the radius of the spool (412) may be less than the width of the sleeve (410) so that the spool (412) remains as a solid unit, instead of being bisected into two halves. Because the slot (418) is a through-hole, a second retaining bit (700) is placed against an opposing end of the spring (422). In other words, the retaining bit (424) is at one end of the spring (422), and the second retaining bit (700) is at the other end of the spring.

In the arrangement of FIG. 7, the first inner groove (414) and the second inner groove (416) are circular or hemispherical. Thus, the retaining bit (424) and the second retaining bit (700) may have similar radii and/or dimensions in order to be sized and dimensioned to fit within the first inner groove (414) and the second inner groove (416). Alternatively, differently sized retaining bits can be used, with separate, differently sized grooves on opposing sides of the inner walls of the sleeve (410).

In use, the dual retaining bits act to increase the retaining force of the retaining bits within the first inner groove (414) or the second inner groove (416). Otherwise, the operation of the spool (412) is similar to the operation described above with respect to FIG. 4 through FIG. 6 (i.e., the spool (412) moves longitudinally when the pressure differential between the inlets becomes high enough to overcome the retaining force). In this manner, the embodiment of FIG. 7 can create an increased retaining force for different expected pressures in different applications.

Still other embodiments are possible. For example, the embodiment shown in FIG. 6 and the embodiments shown in FIG. 7 may be combined. In other words, multiple through-holes with multiple springs and three inner grooves may be used. In another embodiment, multiple slots are present, but some are through-slots and some are blind-hole slots. In still other embodiments, more than two slots, springs, and retaining bits are present, in different arrangements of blind-hole slots and through-slots. Thus, the one or more embodiments described with respect to FIG. 4 through FIG. 7 do not necessarily limit the claimed inventions or other possible embodiments.

The one or more embodiments described herein have a number of advantages over known shuttle valves. For example, the one or more embodiments have a more compact and simple geometry, taking advantage of space inside the spool rather than relying on additional components outside the spool. The one or more embodiments also provide for better control and optimized tolerance and forces for the spring through control of the spring constant.

Additionally, the probability of foreign object debris (FOD) is greatly reduced or eliminated entirely, because the space between the outer wall of the spool and the inner wall of the sleeve can be made much less than the diameter of the retaining bit. Thus, the retaining bit is unable to leave a desired place within the shuttle valve. For this reason, the shuttle valve might not need a strainer in the outlet, thereby further improving simplicity of design and reduction in cost.

Additionally, because the design is compact and efficient, and does not rely on C-springs which are prone to material fatigue, it is easier to perform maintenance on the shuttle valve of the one or more embodiments. Likewise, the expected lifetime of the shuttle valve is also increased. Thus, the cost of manufacturing, using, and performing maintenance on the shuttle valve described herein is further reduced.

The one or more embodiments also provide improved mechanisms for adjusting the retaining force applied by the retaining bits in the inner grooves. Parallel spring configurations (as shown in FIG. 6) or through-hole configurations with multiple bits (as shown in FIG. 7), or combinations thereof, are possible to accommodate a wide range of fluid pressures expected within the shuttle valve.

The one or more embodiments are also easily scalable, and thus may be retrofitted into existing hydraulic systems, including aircraft with hydraulic systems. Accordingly, the shuttle valve of the one or more embodiments may be used in a wide array of hydraulic system applications.

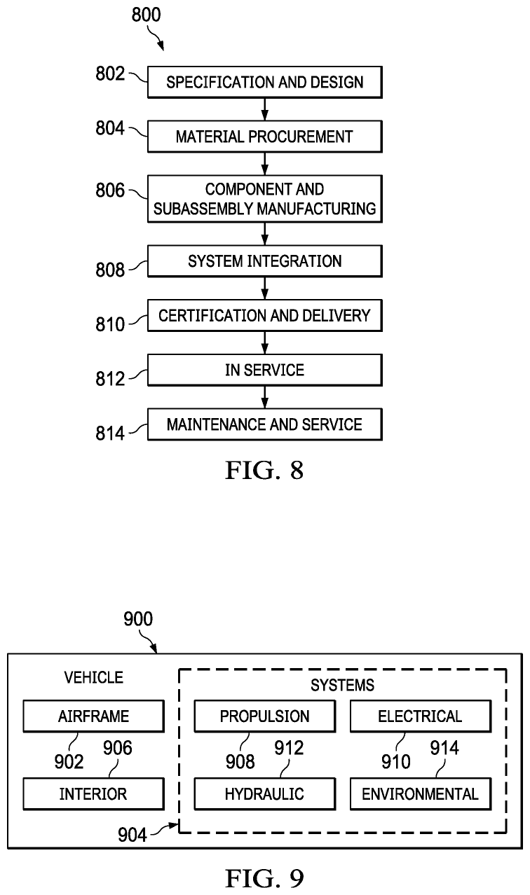

FIG. 8 illustrates an aircraft manufacturing and service method, in accordance with one or more embodiments. FIG. 9 illustrates an aircraft, in accordance with one or more embodiments. FIG. 8 and FIG. 9 should be considered together. The methods and systems described with respect to FIG. 1 through FIG. 9 may be used in the context of the aircraft manufacturing and service method (800) shown in FIG. 8. Similarly, the methods and system described with respect to FIG. 1 through FIG. 9 may be used to rework portions of the aircraft (900) shown with respect to FIG. 9.

Turning to FIG. 8, during pre-production, the exemplary aircraft manufacturing and service method (800) may include a specification and design (802) of the aircraft (900) in FIG. 9 and a material procurement (804) for the aircraft (900). During production, the component and subassembly manufacturing (806) and system integration (808) of the aircraft (900) in FIG. 9 takes place. Thereafter, the aircraft (900) in FIG. 9 may go through certification and delivery (810) in order to be placed in service (812). While in service by a customer, the aircraft (900) in FIG. 9 is scheduled for routine maintenance and service (814), which may include modification, reconfiguration, refurbishment, and other maintenance or service.

Each of the processes of the aircraft manufacturing and service method (800) may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

With reference now to FIG. 9, an illustration of an aircraft (900) is depicted in which an advantageous embodiment may be implemented. In this example, the aircraft (900) is produced by the aircraft manufacturing and service method (800) in FIG. 8. The aircraft (900) may include airframe (902) with systems (904) and an interior (906). Examples of systems (904) include one or more of a propulsion system (908), an electrical system (910), a hydraulic system (912), and an environmental system (914). Any number of other systems may be included.

Although an aerospace example is shown, different advantageous embodiments may be applied to other industries, such as the automotive industry. Thus, for example, the aircraft (900) may be replaced by an automobile or other vehicle or object in one or more embodiments.

The apparatus and methods embodied herein may be employed during any one or more of the stages of the aircraft manufacturing and service method (800) in FIG. 8. For example, components or subassemblies produced in the component and subassembly manufacturing (806) in FIG. 8 may be fabricated or manufactured in a manner similar to components or subassemblies produced while the aircraft (900) is in service (812) in FIG. 8.

Also, one or more apparatus embodiments, method embodiments, or a combination thereof may be utilized during production stages, such as the component and subassembly manufacturing (806) and system integration (808) in FIG. 8, for example, by substantially expediting the assembly of or reducing the cost of the aircraft (900). Similarly, one or more of apparatus embodiments, method embodiments, or a combination thereof may be utilized while the aircraft (900) is in service (812) or during maintenance and service (814) in FIG. 8.

For example, one or more of the advantageous embodiments may be applied during component and subassembly manufacturing (806) to rework inconsistencies that may be found in composite structures. As yet another example, one or more advantageous embodiments may be implemented during maintenance and service (814) to remove or mitigate inconsistencies that may be identified. Thus, the one or more embodiments described with respect to FIG. 1 through FIG. 9 may be implemented during component and subassembly manufacturing (806) and/or during maintenance and service (814) to remove or mitigate inconsistencies that may be identified.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A device comprising:
a sleeve comprising a first end, a second end opposite the first end, and a hole disposed through an outer diameter of the sleeve between the first end and the second end;
a spool comprising a third end and a fourth end opposite the third end, the spool disposed at least partially inside the sleeve and configured to slide along a longitudinal axis of the sleeve;
a spring comprising a fifth end and a sixth end opposite the fifth end, the spring disposed in a slot disposed in the spool, the spring and the slot oriented at least partially in a radial direction relative to the longitudinal axis; and
a retaining bit disposed at the fifth end of the spring, wherein the spring, in a partially compressed state, urges the retaining bit against an inner wall of the sleeve.

2. The device of claim 1, wherein the sleeve further comprises:
a first inner groove in the inner wall, the first inner groove inwardly facing and sized and dimensioned to receive the retaining bit; and
a second inner groove in the inner wall a distance along the longitudinal axis from the first inner groove, the second inner groove inwardly facing and sized and dimensioned to receive the retaining bit.

3. The device of claim 1, wherein:
the slot and the spring are disposed about perpendicular to the longitudinal axis.

4. The device of claim 1, wherein:
the spring comprises a helical spring, and
the slot comprises a blind hole slot.

5. The device of claim 1, further comprising:
a second spring comprising a seventh end and an eighth end opposite the seventh end, the second spring disposed in a second slot disposed in the spool a distance along the longitudinal axis, the second spring and the second slot oriented at least partially in the radial direction relative to the longitudinal axis; and
a second retaining bit disposed at the seventh end of the second spring, wherein the second spring, in a second partially compressed state, urges the second retaining bit against the inner wall of the sleeve.

6. The device of claim 5, wherein the retaining bit comprises a first retaining bit, and wherein the device further comprises:
a first inner groove in the inner wall, the first inner groove inwardly facing and sized and dimensioned to receive the first retaining bit;
a second inner groove in the inner wall a first distance along the longitudinal axis from the first inner groove, the second inner groove inwardly facing and sized and dimensioned to receive the first retaining bit and the second retaining bit; and
a third inner groove in the inner wall a second distance along the longitudinal axis from the first inner groove, the third inner groove inwardly facing and sized and dimensioned to receive the first retaining bit and the second retaining bit.

7. The device of claim 6, wherein the first retaining bit is sized and dimensioned differently than the second retaining bit, and wherein the first groove, the second groove, and the third groove are sized and dimensioned differently relative to each other.

8. The device of claim 1, wherein the slot comprises a through-hole slot, wherein the retaining bit comprises a first retaining bit, and wherein the device further comprises:
a second retaining bit disposed at the sixth end of the spring, wherein the spring, in a partially compressed state, urges the second retaining bit against the inner wall of the sleeve, opposite the first retaining bit.

9. The device of claim 1, wherein the sleeve comprises a cylindrical sleeve, wherein the spool comprises a cylindrical spool, and wherein the sleeve further comprises:
a first circular inner groove in the inner wall, the first circular inner groove inwardly facing and sized and dimensioned to receive a first retaining bit and a second retaining bit; and
a second circular inner groove in the inner wall a distance along the longitudinal axis from the first inner groove, the second circular inner groove inwardly facing and sized and dimensioned to receive the first retaining bit and the second retaining bit.

10. A shuttle valve comprising:
a housing having a first inlet, a second inlet, an outlet, and a manifold chamber in fluid communication with the first inlet, the second inlet, and the outlet;
a sleeve disposed in the manifold chamber, the sleeve comprising a first end, a second end opposite the first end, and a first hole and a second hole disposed through an outer diameter of the sleeve between the first end and the second end;
a spool comprising a third end and a fourth end opposite the third end, the spool disposed at least partially inside the sleeve and configured to slide along a longitudinal axis of the sleeve;
a spring comprising a fifth end and a sixth end opposite the fifth end, the spring disposed in a first slot disposed in the spool, the spring and the first slot oriented at least partially in a radial direction relative to the longitudinal axis; and
a retaining bit disposed at the fifth end of the spring, wherein the spring, in a partially compressed state, urges the retaining bit against an inner wall of the sleeve.

11. The shuttle valve of claim 10, further comprising:
a first inner groove in the inner wall, the first inner groove inwardly facing and sized and dimensioned to receive the retaining bit; and
a second inner groove in the inner wall a distance along the longitudinal axis from the first inner groove, the second inner groove inwardly facing and sized and dimensioned to receive the retaining bit.

12. The shuttle valve of claim 11, wherein:
in a first position, the third end of the spool blocks the first inlet such that a first fluid flow proceeds from the second outlet, through the second hole, and into the outlet; and
in a second position, the fourth end of the spool blocks the second inlet such that a second fluid flow proceeds from the first outlet, though the first hole, and into the outlet.

13. The shuttle valve of claim 12, wherein:
in the first position, the spring urges the retaining bit into the first inner groove; and
in the second position, the spring urges the retaining bit into the second inner groove.

14. The shuttle valve of claim 10, wherein:
the first slot comprises a blind-hole slot.

15. The shuttle valve of claim 10, wherein the first slot comprises a through-hole slot, wherein the retaining bit comprises a first retaining bit, and wherein the shuttle valve further comprises:
a second retaining bit disposed at the sixth end of the spring, wherein the spring, in a partially compressed state, urges the second retaining bit against the inner wall of the sleeve, opposite the first retaining bit.

16. The shuttle valve of claim 10, further comprising:
a second spring comprising a seventh end and an eighth end opposite the seventh end, the second spring disposed in a second slot disposed in the spool a distance along the longitudinal axis, the second spring and the second slot oriented at least partially in the radial direction relative to the longitudinal axis; and
a third retaining bit disposed at the seventh end of the second spring, wherein the second spring, in a second partially compressed state, urges the second retaining bit against the inner wall of the sleeve.

17. The shuttle valve of claim 16, wherein:
the first slot comprises one of a first blind-hole slot or a first through slot; and
the second slot comprises one of a second blind-hole slot or a second through slot.

18. The shuttle valve of claim 17, wherein at least one of the first slot and the second slot comprises at least one of the first through slot and the second through slot, and wherein the shuttle valve further comprises at least one of:
a second retaining bit at the sixth end of the spring, wherein the spring urges the second retaining bit against the inner wall of the sleeve; and
a fourth retaining bit at the eighth end of the second spring, wherein the second spring urges the fourth retaining bit against the inner wall of the sleeve.

19. The shuttle valve of claim 18, wherein the retaining bit comprises a first retaining bit, and wherein the shuttle valve further comprises:
a first inner groove in the inner wall, the first inner groove inwardly facing and sized and dimensioned to receive at least one of the first retaining bit and the third retaining bit;
a second inner groove in the inner wall a first distance along the longitudinal axis from the first inner groove, the second inner groove inwardly facing and sized and dimensioned to receive at least one of the first retaining bit and the third retaining bit, together with at least one of the second retaining bit and the fourth retaining bit; and
a third inner groove in the inner wall a second distance along the longitudinal axis from the first inner groove, the third inner groove inwardly facing and sized and dimensioned to receive the second retaining bit and the fourth retaining bit.

20. An aircraft comprising:
a fuselage;
a hydraulic system connected to the fuselage, the hydraulic system comprising a first fluid line, a second fluid line, a third fluid line, and a shuttle valve, wherein the shuttle valve comprises:
a housing having a first inlet connected to the first fluid line, a second inlet connected to the second fluid line, an outlet connected to the third fluid line, and a manifold chamber in fluid communication with the first inlet, the second inlet, and the outlet;
a sleeve disposed in the manifold chamber, the sleeve comprising a first end, a second end opposite the first end, and a first hole and a second hole disposed through an outer diameter of the sleeve between the first end and the second end;
a spool comprising a third end and a fourth end opposite the third end, the spool disposed at least partially inside the sleeve and configured to slide along a longitudinal axis of the sleeve;
a spring comprising a fifth end and a sixth end opposite the fifth end, the spring disposed in a slot disposed in the spool, the spring and the slot oriented at least partially in a radial direction relative to the longitudinal axis; and
a retaining bit disposed at the fifth end of the spring, wherein the spring, in a partially compressed state, urges the retaining bit against an inner wall of the sleeve.
